(19) United States
(12) Patent Application Publication
(10) Pub. No.: US 2017/0351844 A1
(43) Pub. Date: Dec. 7, 2017

(54) SYSTEM AND METHOD FOR DETERMINING RELATIVE OPERATIONAL PERFORMANCE IN A CLINICAL TRIAL

(71) Applicant: Medidata Solutions, Inc., New York, NY (US)

(72) Inventors: David Lee, New York, NY (US); Michael Elashoff, Hillsborough, CA (US); Joshua Hartman, Fort Washington, PA (US); Richard Kwock, Foster City, CA (US); John Savage, Fair Haven, NJ (US); Steven Schwager, New York, NY (US)

(21) Appl. No.: 15/498,292

(22) Filed: Apr. 26, 2017

Related U.S. Application Data
(63) Continuation-in-part of application No. 29/535,475, filed on Aug. 6, 2015, now Pat. No. D787526.

(51) Int. Cl. G06F 19/00

(52) U.S. Cl. CPC G06F 19/363; G06F 19/324; G06F 19/3406

(57) ABSTRACT

A system for determining relative operational performance in a clinical trial may include a processor, a data comparator and visualizer, and a graphical user interface. The processor filters received clinical data into multiple metric criteria to generate multiple metric data sets and filters each metric data set into a respective industry data set and a respective candidate data set. The processor then calculates statistical measures for each industry data set and candidate data set and transforms each industry data set and candidate data set based on each data set's respective statistical measures. The data comparator and visualizer compares each transformed candidate data set to the transformed industry data set for the respective metric criterion to determine a candidate percentile for each metric criterion. The graphical user interface displays the candidate percentiles for the metric criteria. A method for determining relative operational performance in a clinical trial is also described.

### BACKGROUND

Clinical trials involve the generation of a large volume of clinical data, which are analyzed to assess a new therapy's safety and efficacy. Current complex cloud platform technologies facilitate this process by enabling users around the world to capture a multitude of data points with each patient visit. Such platform technologies systematically generate as a by-product a rich stream of operational data based on numerous ID fields (for sponsors, sites, patients, etc.) and event time stamps as users gather data.

Clinical trial professionals and their sponsors are investing massive amounts of resources into properly executing clinical trials, and are thus highly dependent on the clinical trial sites that conduct the trials. To identify and evaluate areas of operational inefficiency, comparing a clinical trial site to other similar clinical trial sites is useful in determining how well the site is performing regarding one or more operational metrics. Similarly, it is helpful to compare the operational performance of whole studies against similar prior studies or the operational performance of a pharmaceutical sponsor against a group of similar sponsors (e.g., a peer group) or the industry as a whole.

### BRIEF DESCRIPTION OF THE DRAWINGS

FIG. 1 is a block diagram of a system for determining the relative operational performance of an entity in a clinical trial;

FIG. 2 shows processor 30 of FIG. 1 in more detail, according to an embodiment of the present invention;

FIGS. 3A and 3B show parts of data comparator and visualizer 40 of FIG. 1 in more detail, according to an embodiment of the present invention;

FIG. 3C shows a scatterplot of the empirical cumulative distribution function of a variable x, according to an embodiment of the present invention; and

FIG. 4 is a flowchart showing a method for determining the relative performance of an entity in a clinical trial, according to an embodiment of the invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Operational data enable unique, quantitative perspectives on trial timelines, data quality, and costs across the life science industry. Quantifying important aspects of clinical trials creates a centralized, quantitative basis for managing operational aspects of such trials, which results in increased efficiencies in critical areas such as patient enrollment, data monitoring, trial cycle times, and costs. A system and method for determining relative operational performance in a clinical trial have been developed by using statistical analysis and appropriate transformations, including the z-transform.

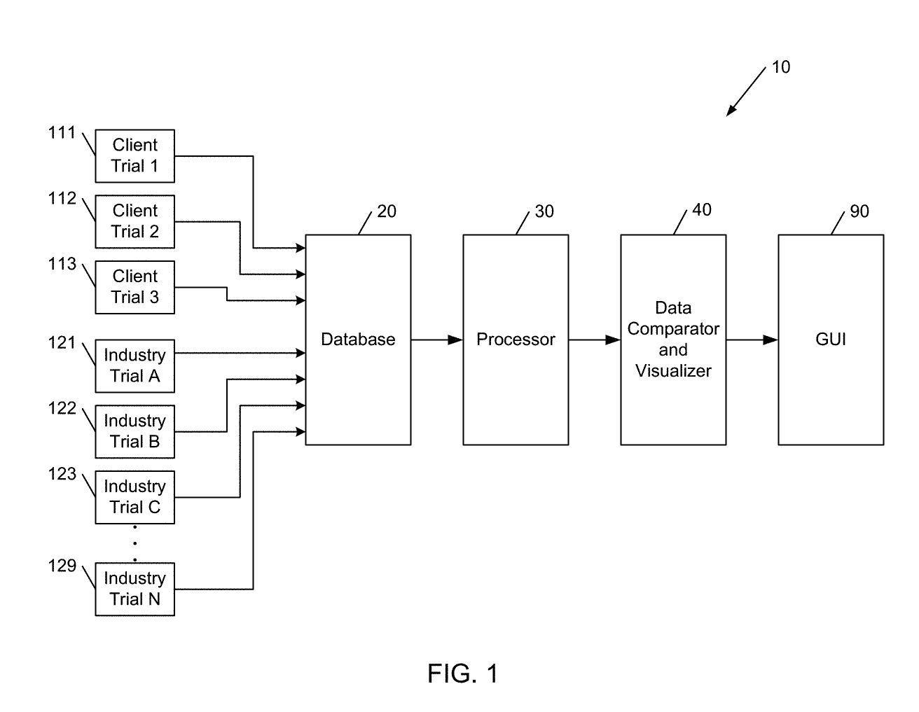

Reference is now made to FIG. 1, which is a block diagram of a system 10 for determining the relative operational performance of an entity in a clinical trial, according to an embodiment of the present invention. Data may be generated during various clinical trials, including client trials 111, 112, and 113 and industry trials 121, 122, 123, . . . , 129, and the data collected from those trials may be stored in a database 20. A “client” may be a sponsor of one or more clinical trials or may be a contract research organization (CRO) that manages or runs one or more clinical trials for various sponsors. The data in the database may be transmitted to a data processor 30, which may identify trials and operational metrics and statistically analyze the operational performance of the client's trials and industry trials and transform the statistical data for comparison. A client's metrics can then be compared to the industry metrics using data comparator and visualizer 40 to determine the client's operational performance against that of industry and to visualize the comparison on graphical user interface (GUI) 90. Comparisons may be visualized as bar graphs, lists of statistics and analyzed data, boxplots, and/or other graphical displays, figures, and tables based on the data.

The word “industry” may be used herein to encompass different combinations of entities that may be compared to the client and may include a peer group or any other combination of competitors or comparison group.

In one embodiment, data may be compared based on therapeutic area rather than on overall clinical trials. For example, client data may be compared to industry data just for clinical trials for oncology. Other therapeutic areas may include central nervous system, immunomodulation, endocrine systems, gastrointestinal, dermatologic, and pain and anesthesia. Data may also be compared based on medical indication (i.e., disease being treated).

In another embodiment, data may be compared based on trial phase (e.g., Phase I, Phase II, Phase III) rather than on overall clinical trials. This view may provide useful information to clients based on phase that may be masked by using an overall view. In another embodiment, data may be compared based on sponsor characteristics (e.g., large pharmaceutical sponsor, small pharmaceutical sponsor, biotech sponsor) rather than on overall clinical trials. In another embodiment, data may be compared based on CRO characteristics, such as determining how a CRO for a trial is performing compared to other CROs running similar trials. In another embodiment, data may be compared based on clinical trial site, to determine how a site in a trial is performing compared to other sites in the trial or in other trials.

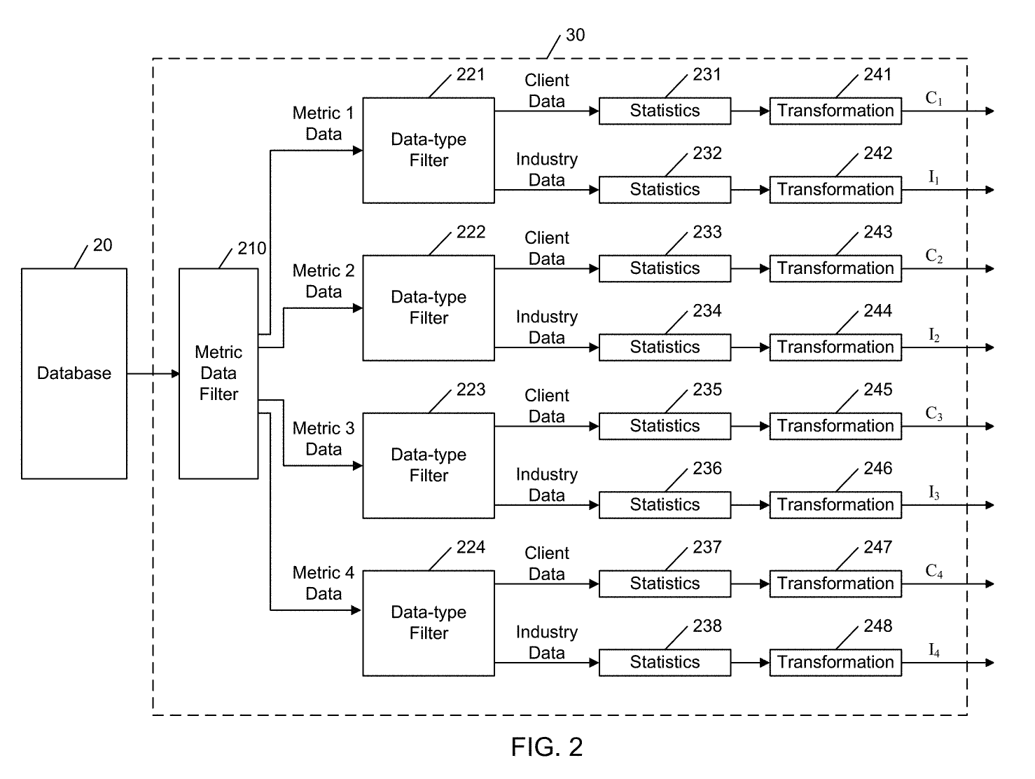

FIG. 2 shows processor 30 of FIG. 1 in more detail. Data, which may include site data, trial data, and industry data, and which may include both clinical data and operational data, may be transmitted from database 20 to processor 30. In one embodiment, processor 30 may include metric data filter 210 that takes the data from database 20 and separates the data into the various metrics. Various categories of metrics may be processed, including enrollment, trial cycle times, monitoring or study conduct, and cost metrics.

Enrollment metrics may include enrollment rate, percentage of high enrolling sites, percentage of non-enrolling sites, number of sites per 100 subjects (or patients), and number of countries per 100 subjects.

Trial cycle times may include the first patient in (FPI) (or enrolled) to last patient in (LPI) (or enrolled) for a trial, DB (database) open to FPI, and last patient visit (LPV) to DB lock.

Monitoring or study conduct may include screen failure rate, on-site monitoring rate, and data correction rate.

Cost metrics may include principal investigator (PI) grant cost per patient and site cost per patient.

Regarding enrollment metrics, one measure of enrollment rate is the rate of enrollment for a trial site or a trial. Enrollment rate for a site may be calculated as the total number of enrolled subjects divided by the total enrollment time for a study site. Enrollment rate for a trial may be calculated as the total number of enrolled subjects divided by the total enrollment time across all sites for a trial.

One measure of percentage of high enrolling sites is the total number of high-enrolling sites divided by the total number of sites for a trial, multiplied by 100. A “high-enrolling site” may be a site that has enrolled more than 1.5 times the mean subject count across all sites for a given trial.

One measure of percentage of non-enrolling sites is the total number of non-enrolling sites divided by the total number of sites for a trial, multiplied by 100. A “non-enrolling site” may be one that does not contain any subjects or patients.

One measure of number of sites per 100 subjects is the total number of trial sites divided by the total number of enrolled subjects, multiplied by 100.

One measure of number of countries per 100 subjects is the total number of unique countries in the trial divided by the total number of enrolled subjects, multiplied by 100.

Regarding trial cycle times, one measure of the FPI to LPI for a trial is the time it takes for enrollment to take place across the whole trial. Some trials may be non-enrolling, in which case this metric would not be measured. In some instances, the system may use a minimum FPI to LPI, so if the actual FPI to LPI is less than such minimum (such as one month), FPI to LPI may be set to that minimum. (If a specified minimum value meets suitable criteria for top quality performance, then using a lower FPI to LPI value may bring no benefit and may even be counterproductive.)

One measure of DB (database) open to FPI is the total number of days from the date of the database launch to the date of enrollment for the first patient in a given trial

One measure of last patient visit (LPV) to DB lock is the time from the last patient last visit to the maximum lock date for all data points in a given trial.

Regarding monitoring or study conduct, screen failure rate may have site-level and study-level measures. One measure of site-level screen failure rate is the number of screen failures (subjects that attempted to enter a trial site but did not enroll) divided by the number of subjects that attempted to enter the trial site (number of screen failures plus number of enrolled subjects). One measure of trial-level screen failure rate is the sum of site-level screen failures divided by the sum of site-level subjects that attempted to enter the trial (sum of site-level screen failures plus the sum of site-level enrolled subjects).

On-site monitoring rate may have a site-level calculation and a trial-level calculation. One measure of a site-level on-site monitoring rate is the total number of days a monitor is on a site divided by the total number of active days for the site. One measure of a trial level on-site monitoring rate is the sum of the site-level on-site days divided by the sum of the site-level active days.

Data correction rate may have a site-level calculation and a trial-level calculation. One measure of a site-level data correction rate is the number of changed data points for a site divided by the total number of data points for that site. One measure of a trial level data correction rate is the sum of site-level changed data points divided by the sum of site-level data points for a given trial.

Regarding cost metrics, principal investigator (PI) grant cost per patient (also known as adjusted grant total per patient) may have a site-level calculation and a trial-level calculation. One measure of PI grant cost per patient is the grant total minus an IRB fee, a fixed fee, a failure fee, a grant adjustment, and lab cost (all in US Dollars), divided by the total number of patients for a given trial site. One measure of a trial level PI grant cost per patient is the sum of site-level adjusted grant total divided by the total number of patients for a given trial.

Site cost per patient may have a site-level calculation and a trial-level calculation. One measure of site cost per patient is the grant total in US Dollars divided by the total number of patients for a given study site. One measure of a trial level site cost per patient is the sum of site-level grant total divided by the total number of patients for a given trial.

This list of categories and metrics is not exclusive or exhaustive. Other categories of metrics and other metrics in these categories may be used to measure operational performance.

Referring back to FIG. 2, data for each metric may be input into a data-type filter 221-224 that separates client (or “candidate”) data from industry data. Each of these sets of data may be input to a statistics module 231-238 to develop statistics for the data. Statistics may include mean, median, standard deviation, mean and median absolute deviation, variance, minimum, maximum, and percentiles, and others. Each statistic may be input to transformation module 241-248 to calculate an appropriate transformation, such as the z-transform, for each statistic for client and industry data, respectively, Cₙ or Iₙ. As is described in the paragraphs below, statistical analysis may involve modification of the data distributions prior to determining the statistics.

An appropriate transformation is any procedure that enables the comparison of client data to industry data on the same scale. The embodiments in the next few paragraphs are not exhaustive. Each of them is based on either the standardized normal distribution or the empirical cumulative distribution function.

One embodiment may use a z-transform, which may be calculated by taking each data point, subtracting the mean, and then dividing by the standard deviation. This converts the distribution of the data to a standardized distribution that has mean equal to 0 and standard deviation equal to 1, which allows client data to be compared to industry data on the same scale.

Embodiments of the present invention may use different statistical measures of “center” and “variability” for calculating the appropriate transformation. The z-transform embodiment described above uses the arithmetic mean as the statistical measure of center and the standard deviation as the statistical measure of variability.

Another embodiment may use the median as the statistical measure of center and the median absolute deviation as the statistical measure of variability. This embodiment is considered more robust to outliers than the z-transform.

Another embodiment may use a Winsorized mean as the statistical measure of center and a Winsorized standard deviation as the statistical measure of variability. A Winsorized distribution sets all values outside a specified percentile to that percentile value. Thus, an 80% Winsorized distribution sets all values above the 90th percentile to the value corresponding to the 90th percentile and all values below the 10th percentile to the value corresponding to the 10th percentile. Then the mean (i.e., Winsorized mean) and standard deviation (i.e., Winsorized standard deviation) of this modified distribution are calculated and used to compute the z-transform.

Similar to the Winsorized distribution is a trimmed distribution. A trimmed distribution truncates the tails by discarding all values outside a specified percentile. Thus, a 10% trimmed distribution deletes all values above the 90th percentile and below the 10th percentile. Then the mean and standard deviation of this modified distribution are calculated and used to compute the z-transform.

Other variations on the statistical measures of center and variability may be used, including using the mean absolute deviation instead of the standard deviation to calculate a modified z-transform.

Another embodiment may be based on the empirical cumulative distribution function (ECDF). This approach may use the industry data to calculate an ECDF and then evaluate the client data relative to this ECDF, assigning a suitable score to the client data. This approach transforms the client data into a score that corresponds to a position on the industry ECDF. An embodiment based on the ECDF may incorporate components that use methodology derived from kernel density estimation, polynomial spline regression, Bernstein polynomial estimation, and other methods applicable to ECDFs.

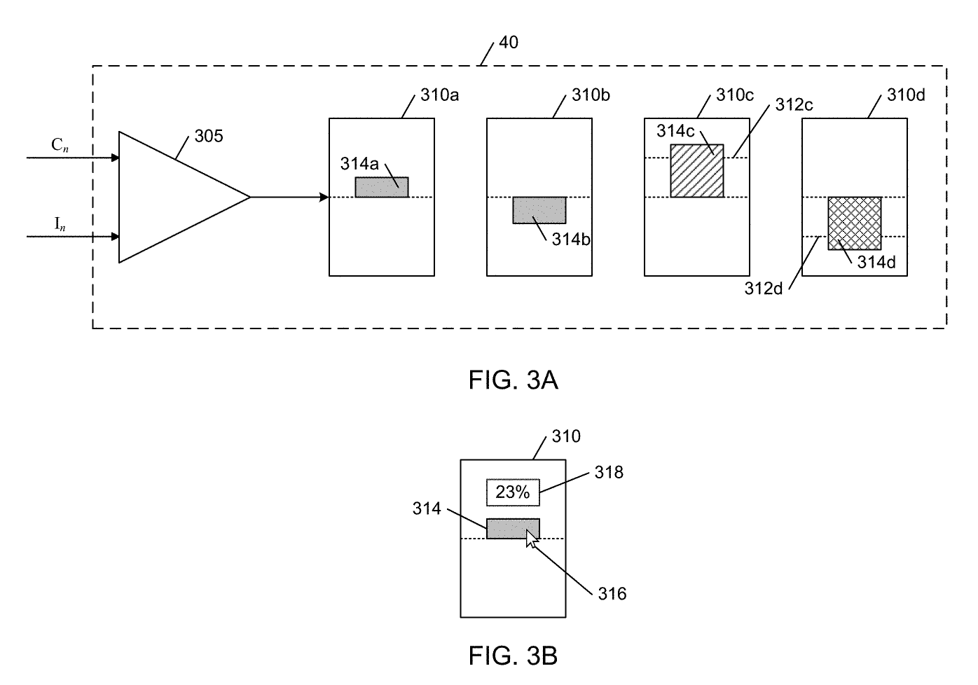

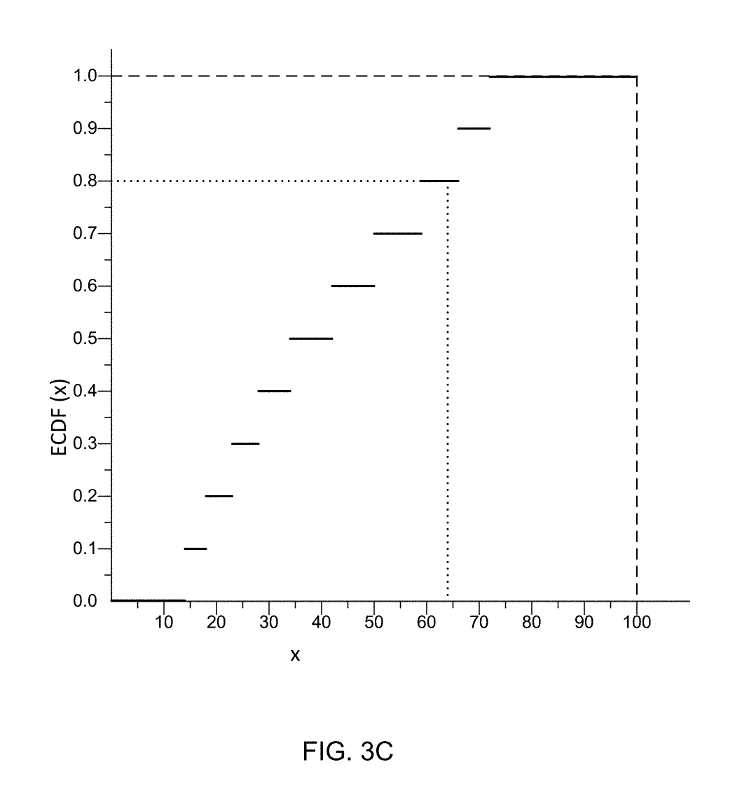

The ECDF determines the position of the client data in the distribution of the relevant industry data. For example, if the industry data consists of ten values—14, 18, 23, 28, 34, 42, 50, 59, 66, 72—and the client data value is 64, then the ECDF score of the client data value is 0.80, because the client data value is greater than or equal to eight of the ten industry values, and this fraction constitutes 8/10=0.80 of the industry data values. FIG. 3C shows a scatterplot of ECDF(x), and the ECDF score of 64 in this example is indicated using dotted lines. This basic ECDF score, the proportion of the industry data values that are less than or equal to the client data value, may be adjusted to improve the performance of the ECDF method by smoothing its discontinuities. In the example, the basic ECDF scores of the client data values 65 and 66 are 0.80 and 0.90, respectively; a statistically-based smoothing procedure may be used to reduce this jump of 0.10 in the ECDF score.

The transformation value for each statistic for client data (however calculated as just described), Cₙ, may then be transmitted to data comparator and visualizer 40, a part of which is shown in FIG. 3A. For each transformation value for client data, Cₙ, there may be a comparator 305 that compares this client transformation value to the transformation value of the industry data, Iₙ, as shown in 310a, 310b, 310c, and 310d, each of which is a depiction of a possible comparison. In 310a, the client transformation value is better than the industry transformation value; in 310b, the client transformation value is worse than the industry transformation value; in 310c, the client transformation value is much better than the industry transformation value, where the comparison exceeds level 312c; and in 310d, the client transformation value is much worse than the industry transformation value, where the comparison is lower than level 312d. The shading of the comparison, shown in 314a, 314b, 314c, and 314d, may indicate the level of difference between the client transformation value and the industry transformation value. In one example, a positive or negative comparison having a magnitude below a certain level, e.g., level 312c, 312d, may result in a certain shading or a certain color, as shown in 310a and 310b. In another example, a comparison having a positive magnitude at or above a certain level, e.g., level 312c, may result in a different shading or color, as shown in 310c. In yet another example, a comparison having a negative magnitude at or below a certain level, e.g., level 312d, may result in yet another shading or color. In an embodiment shown in FIG. 3B, moving cursor 316 over box 314 may cause label 318 to pop up to indicate the actual value of the client's transformation value. Alternatively the value of the client's transformation value may be displayed within the shaded region 314 in FIGS. 3A or 3B. In addition to showing relative performance using the graphs in FIG. 3B, the data may be visualized using lists of the statistics and the analyzed data and/or graphical plots, including, but not limited to, boxplots and histograms.

The parts and blocks shown in FIGS. 1, 2, 3A, and 3B are examples of parts that may comprise system 10, processor 30, and data comparator and visualizer 40 and do not limit the parts or modules that may be included in or connected to or associated with this system and its components. For example, client trial data may be a subset of industry trial data. Processor 30 may also include filters for therapeutic area, indication, and trial phase. Also, metric data filter 210 and data-type filters 221-224 may reside in different physical “boxes” or devices, and the connections between them may be wired or wireless, via physically close connections or over a network.

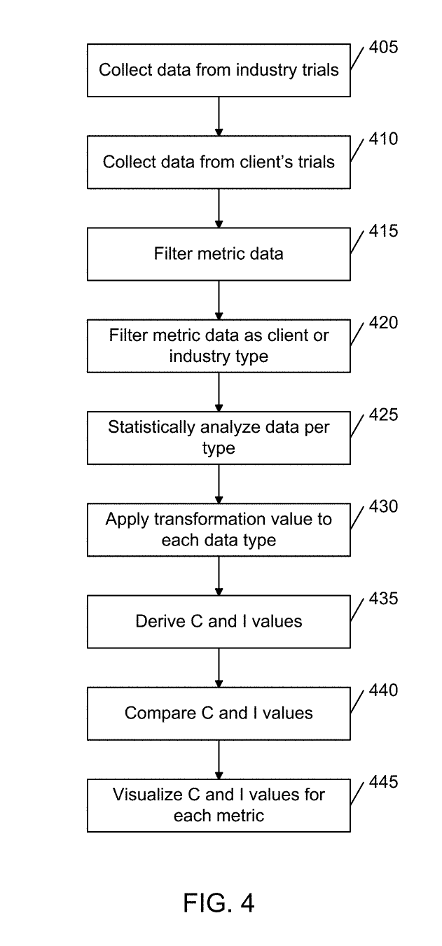

Reference is now made to FIG. 4, which is a flowchart showing a method for determining the relative performance of an entity in a clinical trial, according to an embodiment of the invention. In operation 405, data may be collected from a variety of clinical trials throughout the industry. The data may include clinical data and operational data related to a variety of metrics. In operation 410, data may be collected from the client's trials. Alternatively, to the extent the industry trial data already includes data related to the client's trials, the latter data may be separated out from the industry trial data. In operation 415, data related to various metrics may be filtered or separated out. As described above with respect to FIG. 2, various categories of metrics may be used. And in operation 420, the metric data may be further separated into client or industry data. In operation 425, the client and industry data may be statistically analyzed to modify the data distribution and/or to calculate mean, median, standard deviation, mean and median absolute deviation, variance, minimum, maximum, and percentiles, and other statistics. In operation 430, the transformation value may be calculated or applied to each data distribution as modified, including standard, Winsorized, median, or other type. The Cₙ and Iₙ values may then be derived or calculated in operation 435 and then compared in operation 440. The Cₙ and Iₙ values for each metric, overall and for each therapeutic area, indication, or phase may be visualized in operation 445.

Besides the operations shown in FIG. 4, other operations or series of operations may be used to determine the relative performance of an entity in a clinical trial. For example, data may be visualized using more than one of therapeutic area, indication, and phase. However, data may not be displayed if there are not enough samples for a given plot, both to protect anonymity and because certain of the transformations require a minimum number of studies in order to calculate the statistics. Moreover, the actual order of the operations in the flowchart may not be critical.

One benefit of the present invention is that it provides a client with information regarding how it stands against others in its peer group or other grouping of competitors, both overall and for different therapeutic areas, indications, and phases. The present invention differs from other systems that provide information about clinical trial operational performance. For example, those systems may not use transformation values, thus making it difficult to compare different scopes of data.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system for determining relative operational performance in a clinical trial, comprising:
a processor for:
filtering received clinical data into a plurality of metric criteria to generate a plurality of metric data sets;
filtering each metric data set into a respective industry data set and a respective candidate data set;
calculating statistical measures for each industry data set and candidate data set; and
transforming each industry data set and candidate data set based on each data set's respective statistical measures;
a data comparator and visualizer for comparing each transformed candidate data set to the transformed industry data set for the respective metric criterion to determine a candidate percentile for each metric criterion; and
a graphical user interface for displaying the candidate percentiles for the metric criteria.

2. The system of claim 1, wherein the statistical measures comprise a statistical measure of center and a statistical measure of variability.

3. The system of claim 2, wherein the statistical measure of center is the arithmetic mean of each data set and the statistical measure of variability is the standard deviation of each data set.

4. The system of claim 2, wherein the statistical measure of center is the median of each data set and the statistical measure of variability is the median absolute deviation of each data set.

5. The system of claim 2, wherein the statistical measure of center is the Winsorized mean of each data set and the statistical measure of variability is the Winsorized standard deviation of each data set.

6. The system of claim 2, wherein a trimmed distribution is used, the statistical measure of center is the mean of the trimmed distribution of each data set and the statistical measure of variability is the standard deviation of the trimmed distribution of each data set.

7. The system of claim 1, wherein the statistical measures comprise an empirical cumulative distribution function (ECDF) for each industry data set and a score for each client data set that corresponds to a position on the industry ECDF.

8. The system of claim 1, wherein there are at least five metric criteria and all of the candidate percentiles for the metric criteria are displayed in a single view.

9. The system of claim 1, wherein the candidate data set and industry data set are further filtered by therapeutic area.

10. The system of claim 9, wherein:
the processor is operable to calculate a statistical measure of center and a statistical measure of variability for each industry data set and candidate data set per therapeutic area and transform each industry data set and candidate data set per therapeutic area based on each data set's respective statistical measures of center and variability;
the data comparator and visualizer is operable to compare each transformed candidate data set for the therapeutic area to the transformed industry data set for the respective metric criterion for the therapeutic area to determine a candidate percentile for each metric criterion for each therapeutic area; and
the graphical user interface is operable to display the candidate percentiles for the metric criteria and therapeutic areas.

11. The system of claim 10, wherein there are at least five metric criteria and at least three therapeutic areas and all of the candidate percentiles for the metric criteria for the therapeutic areas are displayed in a single view.

12. The system of claim 10, wherein the graphical user interface displays a plurality of comparison plots in a single view, each comparison plot comparing transformed candidate data to transformed industry data for each therapeutic area and each metric criterion.

13. A method for determining relative operational performance in a clinical trial, comprising:
receiving clinical data from a plurality of clinical data sources;
filtering the clinical data into a plurality of metric criteria to generate a plurality of metric data sets;
filtering each metric data set into a respective industry data set and a respective candidate data set;
calculating statistical measures for each industry data set and candidate data set;
transforming each industry data set and candidate data set based on each data set's respective statistical measures;
comparing each transformed candidate data set to the transformed industry data set for the respective metric criterion to determine a candidate percentile for each metric criterion; and
displaying the candidate percentiles for the metric criteria on a graphical user interface.

14. The method of claim 13, wherein the statistical measures comprise a statistical measure of center and a statistical measure of variability.

15. The method of claim 14, wherein the statistical measure of center is the arithmetic mean of each data set and the statistical measure of variability is the standard deviation of each data set.

16. The method of claim 14, wherein the statistical measure of center is the median of each data set and the statistical measure of variability is the median absolute deviation of each data set.

17. The method of claim 14, wherein the statistical measure of center is the Winsorized mean of each data set and the statistical measure of variability is the Winsorized standard deviation of each data set.

18. The method of claim 14, wherein a trimmed distribution is used, the statistical measure of center is the mean of the trimmed distribution of each data set, and the statistical measure of variability is the standard deviation of the trimmed distribution of each data set.

19. The method of claim 13, wherein the statistical measures comprise an empirical cumulative distribution function (ECDF) for each industry data set and a score for each client data set that corresponds to a position on the industry ECDF.

20. The method of claim 13, wherein there are at least five metric criteria and all of the candidate percentiles for the metric criteria are displayed in a single view.

21. The method of claim 13, wherein the candidate data set and industry data set are further filtered by therapeutic area.

22. The method of claim 21, further comprising:
calculating a statistical measure of center and a statistical measure of variability for each industry data set and candidate data set per therapeutic area;
transforming each industry data set and candidate data set per therapeutic area based on each data set's respective statistical measures of center and variability;
comparing each transformed candidate data set for the therapeutic area to the transformed industry data set for the respective metric criterion for the therapeutic area to determine a candidate percentile for each metric criterion for each therapeutic area; and
displaying the candidate percentiles for the metric criteria and therapeutic areas on the graphical user interface.

23. The method of claim 22, wherein there are at least five metric criteria and at least three therapeutic areas and all of the candidate percentiles for the metric criteria for the therapeutic areas are displayed in a single view.

24. The method of claim 22, wherein the graphical user interface displays a plurality of comparison plots in a single view, each comparison plot comparing transformed candidate data to transformed industry data for each therapeutic area and each metric criterion.
